(19) United States
(12) Patent Application Publication
(10) Pub. No.: US 2006/0290913 A1
(43) Pub. Date: Dec. 28, 2006

(54) Microlithography exposure method and projection exposure apparatus for carrying out the method

(75) Inventors: Nils Dieckmann, Aalen (DE); Manfred Maul, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/475,871

(22) Filed: Jun. 28, 2006

(30) Foreign Application Priority Data
Jun. 28, 2005 (DE) 102005031084.2

(51) Int. Cl. G03B 27/42

(52) U.S. Cl. 355/53; 355/77

(57) ABSTRACT

In an exposure method for producing an image of a pattern, arranged in the object surface of a projection objective, in the image surface of the projection objective, the mask is illuminated with illumination radiation with the aid of the illumination system. The radiation varied by the mask and which enters the projection objective is thereby produced downstream of the mask. The projection objective is transirradiated with this radiation. An astigmatic variation of the radiation varied by the mask is effected in the region of at least one pupil surface of the projection objective, the astigmatic variation being designed such that an anisotropy of properties of the radiation striking the image surface that leads to direction-dependent contrast differences is at least partially compensated. The astigmatic variation can be achieved, for example, with the aid of an elliptical diaphragm or an elliptical transmission filter.

The following disclosure is based on German Patent Application No. 10 2005 031 084.2 filed on Jun. 28, 2005, which is incorporated into this application by reference.

### BACKGROUND OF THE INVENTION

1. Field of the Invention

The invention relates to an exposure method for producing an image of a pattern, arranged in an object surface of a projection objective, in the image surface of the projection objective, and to a projection exposure apparatus for carrying out this method.

2. Description of the Related Art

Microlithography exposure methods and projection apparatuses are used to produce semiconductor components and other finely structured subassemblies. They serve for projecting patterns of photomasks or lined plates, generally referred to below as masks or reticles, onto an article coated with a radiation-sensitive layer, for example onto a semiconductor wafer coated with photoresist, with very high resolution on a demagnifying scale.

It is of decisive importance in the photolithographic patterning process of semiconductor components that all structural directions, in particular horizontal and vertical structures, be imaged with substantially the same contrast. Disturbances in this desired directional independence of the imaging are frequently denoted as h-v differences or variation in the critical dimensions (CD variation). These directionally dependent contrast differences can have various causes that act alternatively or cumulatively.

The microlithography projection exposure apparatus comprises in general an illumination system for illuminating the mask and a projection objective that follows after the mask and with the aid of which the pattern of the mask is imaged into the image plane of the projection objective. One or more deflecting mirrors can be provided in the illumination beam path of a projection exposure apparatus, that is to say between the light source and the exit of the illumination system, in order to reduce the overall length of the illumination unit. Owing to different reflectivities for s- and p-components of the radiation coming from the light source, it is possible, for example, for partially polarized light to result in the region of the mask surface from initially unpolarized light. The illumination of masks with partially polarized light can lead to the imaging of horizontal and vertical structures with a different contrast.

Other causes can lie in the design of the projection objectives. In order to produce ever finer structures, attempts are being made, on the one hand, to enlarge their image-side numerical aperture (NA) and, on the other hand, to use ever shorter wavelengths, preferably ultraviolet with wavelengths of less than approximately 260 nm. Since only a few sufficiently transparent materials are still available in this wavelength region for producing the optical components, the Abbe constants of which are, moreover, close to one another, it is difficult to provide purely refractive, rotationally symmetrical systems with adequate correction of chromatic aberrations. Consequently, for this wavelength region increasing use is being made of catadioptric systems in which refracting and reflecting components, in particular lenses and imaging mirrors, are combined.

When using imaging reflecting surfaces, it is advantageous to employ beam splitters if the aim is to achieve imaging which is free from obscuration and vignetting. Both systems with geometric beam splitting, and also ones with physical beam splitting, for example with polarization beam splitting are possible. The use of reflecting surfaces in the projection objective can likewise contribute to the production of h-v differences in imaging.

Particularly when use is made of synthetic quartz glass and fluoride crystals, such as calcium fluoride, it is moreover to be borne in mind that these material are photoelastically active. Because of induced or, in the case of fluoride crystals, intrinsic birefringence, they can therefore cause polarization-varying effects at the penetrating light, and these can likewise contribute to the production of h-v differences.

Various proposals have already been made for avoiding directionally dependent contrast differences. European patent application EP 964 282 (corresponding to U.S. Pat. No. 6,466,303) addresses the problem that in the case of catadioptric projection systems with deflecting mirrors a preferred polarization direction is introduced in the case of the penetrating light, being yielded by the fact that the multiply coated deflecting mirrors have different reflectivities for s- and p-polarized light. Consequently, light that is still unpolarized in the mask plane (reticle plane) is partially polarized in the image plane, and this leads to the directional dependence of the imaging properties. This effect is counteracted according to the proposal made there by virtue of the fact that the production of partially polarized light with a prescribed degree of residual polarization produces in the illumination system a lead in polarization that is compensated by the deflecting mirrors of the projection optics such that substantially unpolarized light exits at the output thereof.

EP 0 602 923 B1 (corresponding to U.S. Pat. No. 5,715,084) discloses a catadioptric projection objective with a polarization beam splitter that is likewise intended to be optimized with regard to contrast differences dependent on structural direction. The projection objective operated with linearly polarized light has between its polarization beam splitter cube and the image plane a device for changing the polarization state of the penetrating light, by means of which the incident linearly polarized light is converted into circularly polarized light (as equivalent to unpolarized light). A corresponding proposal is also made in EP 0 608 572 (corresponding to U.S. Pat. No. 5,537,620). A λ/4 plate is respectively provided as a device for changing the polarization state. For short wavelengths, in particular, such elements can be produced with the required precision only with difficulty. In addition, it is possible to influence only polarization-induced causes of contrast differences.

U.S. Pat. No. 5,222,112 describes a projection system, operating exclusively with mirror components, for extreme ultraviolet (EUV) light, in the case of which the problems of different reflectivities for s- and p-polarized light on multiply coated mirrors likewise occur. A convex mirror arranged in the region of a pupil surface of the projection objective has a rotationally symmetrical reflectivity distribution with reflectivity decreasing toward the edge of the mirror, in order to improve the imaging properties of the system. An X-ray transparent transmission filter with an appropriate, rotationally symmetrical transmission function is mentioned as an alternative.

### SUMMARY OF THE INVENTION

It is one object of the invention to provide an exposure method and a projection exposure apparatus suitable therefore that enable imaging substantially without contrast differences for various structural directions.

To address these and other objects the invention, according to one formulation of the invention, provides an exposure method for producing an image of a pattern, arranged in the object surface of a projection objective, in the image surface of the projection objective, comprising:

illuminating the mask with illumination radiation in order to produce a radiation varied by the mask;

transirradiating the projection objective with the radiation varied by the mask;

astigmatically varying the radiation varied by the mask in the region of at least one pupil surface of the projection objective in such a way that an anisotropy of properties of the radiation striking the image surface that leads to direction-dependent contrast differences is at least partially compensated.

According to another formulation, the invention provides a projection exposure apparatus for the microlithographic production of semiconductor components and other finely structured subassemblies, comprising:

an illumination system for illuminating a mask with illumination radiation;

a projection objective for imaging a pattern, arranged in the object surface of the projection objective, of a mask into the image surface of the projection objective, at least one pupil surface lying between the object surface and the image surface; and

at least one astigmatic optical element, arranged in the region of the pupil surface, configured to astigmatically vary the radiation striking the optical element such that an anisotropy of properties of the radiation striking the image surface that leads to direction-dependent contrast differences is at least partially compensated.

Advantageous developments are specified in the dependent claims. The wording of all the claims is incorporated in the description by reference.

In the case of an exposure method according to the invention for producing an image of a pattern, arranged in the object surface of a projection objective, in the image surface of the projection objective, the mask is illuminated with illumination radiation with the aid of the illumination system. This gives rise downstream of the mask to a radiation varied by the mask, which enters the projection objective. The projection objective is transirradiated with this radiation. In the region of at least one pupil surface of the projection objective, an astigmatic variation of the radiation varied by the mask is effected, the astigmatic variation being designed such that an anisotropy of properties of the radiation striking the image surface that leads to direction-dependent contrast differences is at least partially compensated.

The term “astigmatic variation” in the meaning of this application describes in general intervening in the radiation beam in the region of a pupil surface of the projection objective with the aid of an effect function that is non-rotationally symmetric with reference to the optical axis of the system. In this case, deviations of the effect function from a rotational symmetry lie clearly outside the asymmetry effected by manufacturing tolerances.

In one development of the invention, the astigmatic variation comprises intervening in the transmission behavior of the projection objective in accordance with a non-rotationally symmetric (astigmatic) transmission function. This essentially influences only the intensity distribution of the radiation in the region of the pupil surface. It has emerged that intervening in this way near the pupil in the energy distribution or intensity distribution can effectively reduce or largely remove the asymmetries of the radiation that lead to directionally dependent contrast differences, doing so independently of their causes. In particular, it is possible to compensate polarization astigmatism with “scalar means”.

The transmission function can be influenced with the aid of at least one element that can be transirradiated and which has a non-rotationally symmetric transmission distribution. It is also possible to influence the total transmission of a system astigmatically with the aid of at least one reflecting element, for example with the aid of a mirror that has an astigmatic reflectivity distribution.

Alternatively, or in addition, the astigmatic variation can comprise intervening in the polarization properties of the penetrating radiation in the near-pupil region. For example, a polarization filter or another element influencing the polarization state and having an astigmatic effect can be used.

A few embodiments of the invention are distinguished in that the astigmatic variation comprises intervening near the pupil with a substantially elliptic effect function. If intervening in the transmission behavior is required, this can be done, for example, with the aid of an elliptical diaphragm (diaphragm with an elliptical aperture) or with the aid of a transmission filter or a reflection filter with an elliptic transmission function or reflectivity function. Whereas in the case of a diaphragm there is generally a sharp transition between transmitting and/or reflecting and blocking regions, in the case of a transmission filter (reflection filter) a profile or gradient is produced between regions of high transmission (reflection) and low transmission (reflection).

An “elliptic effect function” in the sense of this application is an effect function in the case of which the optical effect of an element in a first direction perpendicular to the optical axis differs significantly from that in a second direction perpendicular thereto, a continuous or stepped transition of the efficiency taking place between the directions. Elliptical shapes resulting from a unilateral compression or stretching of a circle are possible. An “ellipse” is preferably aligned with reference to the structures to be imaged such that the axes of the ellipse are aligned parallel or perpendicular to the structures to be imaged.

An optical element that effects, for example, elliptical masking out or elliptical filtering can be a separate optical element that is installed in at least one near-pupil region in addition to lenses, mirrors and/or other elements of the optical design. It is also possible to achieve the optical effect of a transmission or reflection filter or of a diaphragm by means of a suitable coating on at least one near-pupil optical surface present in any case. It is possible to dispense with separate astigmatic optical elements in the projection objective in this case.

In many instances, it can suffice to bring about the astigmatic variation statically, that is to say without variation, for example by installing an appropriate filter or an appropriate diaphragm permanently in a projection objective, or by applying an appropriate coating to a lens surface or the like. The astigmatic effect function can be adapted to the typical transmittance properties of the corresponding projection objective in order to compensate them. The design can also take account, if appropriate, of the influence of the upstream illumination system.

It is also possible to bring about the astigmatic variation by means of optical elements with a variable effect function, for example, by means of a diaphragm that is variable with reference to the transmission function and in the case of which the size and/or the shape of the aperture is variable, or by means of an externally drivable filter with a variable filter function.

The astigmatic variation in the region of a pupil surface can be carried out, for example, with the aid of at least one elliptically shaped or shapable diaphragm, with the aid of at least one astigmatic gray filter (transmission or reflection filter) with a suitable gray-scale value profile or reflectivity profile, with the aid of at least one astigmatically deformed or deformable near-pupil optical element, and/or with the aid of near-pupil elements that are provided with an astigmatically shaped, optical surface (of astigmatic dimensions). Consideration is given in the case of the astigmatically deformable optical elements to, for example, astigmatically deformable lenses or plates that are held, for example, in a separate mount which is equipped with a suitable manipulator technology. Likewise possible are adaptive mirrors, for example an astigmatically deformable concave mirror of a catadioptric projection objective.

It is provided in the case of preferred exemplary embodiments that at least one variable optical element for variably influencing the properties of the radiation striking the astigmatic optical element is arranged in the beam path upstream of the astigmatic optical element. This measure is advantageous particularly in conjunction with astigmatic optical elements that are static, that is to say whose effect is invariable, in order to enable fine tuning of the overall properties of the optical system so as to minimize CD variations. With the aid of such an element, it is possible, for example, to adjust the degree of residual polarization of the radiation striking the image plane of the projection objective, doing so in such a way that the effect of an astigmatic filter fitted near the pupil in the projection objective, and the degree of residual polarization that causes the directional dependence of imaging cancel one another out, and it is thus possible for all structural directions to be imaged with substantially the same contrast.

Although it is possible to provide the variable optical element in the projection objective, it is preferred when the variable optical element is arranged in the illumination system, that is to say upstream of the mask (reticle) to be illuminated. This makes it possible to influence the properties of the radiation incident on the reticle.

In the case of illumination systems that have a pupil surface which is optically conjugate to a pupil surface of the projection objective, the variable optical element can be arranged in the region of this pupil surface (or of a pupil surface of the illumination system conjugate thereto). In this way, the optical effects of the variable optical element and of the astigmatic optical element in the projection objective can be “added” or adapted to one another in a particularly simple way.

If the illumination system has at least one deflecting mirror in order, for example, to satisfy requirements as to installation space, the variable optical element is preferably arranged downstream of the last deflecting mirror of the illumination system, in order to be able during compensation to take account of changes to the properties of the illumination radiation caused by this deflecting mirror.

The variable optical element can be a polarizer for variably influencing the polarization state from the striking radiation. What can be involved is a retardation element with the effect of a λ/2 plate that can preferably be arranged in a fashion capable of rotation about its optical axis. Such an element can, for example, be used to set a preferred polarization direction of the output radiation by rotating the element into any desired radial direction. The variable optical element can also be fashioned in the manner of a wedge plate polarizer. An exemplary embodiment therefore is disclosed, for example, in EP 0 964 282, the disclosure content of which in this regard is incorporated in this description by reference.

In the case of illumination systems where a rod-shaped light integrator, for example a cuboid rod made from quartz glass or calcium fluoride, is used as homogenizer, it is also possible to control the degree of residual polarization in the reticle plane by rotating the polarization direction at the system input, for example by means of a λ/2 plate.

In particular, the combination of an astigmatic optical element, static if appropriate, in the projection objective in conjunction with an adjustment of the degree of residual polarization in the illumination system permits h-v differences of the imaging to be corrected in a simple and, if appropriate, stepless fashion.

Alternatively, or in addition, the variable setting of at least one property of the radiation upstream (or before) the astigmatic variation of the radiation within the projection objective may be brought about or assisted by influencing the illumination radiation striking the mask (or reticle) by appropriately influencing the transmission behaviour of the illumination system in accordance with a non-rotationally symmetric transmission function. For example, the illumination system may include a transmission filter device having a variable transmission function such that the cross-sectional shape of the illumination beam within the illumination system and/or the intensity distribution within the illumination beam can be set variably as desired. The transmission filter device may include or may be formed by a diaphragm device defining an aperture having variable cross-sectional aperture shape. Various transmission filter devices suitable for that purpose are disclosed in applicants International patent application published as WO 2005/006079 or German patent application DE 10 2004 063 314 filed on Dec. 23, 2004 (corresponding to International patent application PCT/EP2005/009165). The disclosures of these patent applications are incorporated herein by reference.

In any case the astigmatic influence of the astigmatic optical element arranged at or near the pupil surface of the projection objective and the non-rotationally symmetric influence of the further astigmatic optical element upstream thereof, particularly within the illumination system, may be adapted with respect to each other such that a combined effect allows to positively influence the direction-dependent contrast differences in the region of the image plane of the projection objective.

The invention may be used in systems having purely refractive (dioptric) projection objectives. The invention may also be used in exposure systems where the projection objective is a catadioptric projection objective having at least one concave mirror provided in addition to a number of transparent lenses. The catadioptric projection objective may include at least one planar deflecting mirror, which typically may be arranged such that the deflecting mirror deflects radiation coming from the object surface towards the concave mirror or such that radiation coming from the concave mirror is deflected towards the image surface. In many embodiments, two planar deflecting mirrors arranged at right angles are used such that object plane and image plane are arranged parallel to each other. Although catadioptric projection objectives having no intermediate image may be improved by the invention, in other embodiments the catadioptric projection objective is designed to generate at least one intermediate image between the object surface and the image surface. Basic design types of catadioptric projection objectives having planar deflecting mirrors which may be improved by implementing the invention are shown, for example, in U.S. Pat. No. 6,466,303 (mentioned in the outset of this application), U.S. Pat. No. 6,717,764, or U.S. Pat. No. 6,496,306 B1 (by the applicant), dislosing systems having exactly one intermediate image, US 2003/0234912 or WO 2005/111698 A2 by the applicant dislosing systems having two intermediate images. The disclosure of the applicant's applications or patents is incorporated herein by reference.

In some embodiments, the direction-dependent contrast differences in the image plane (h-v-difference) is at least partly compensated for by providing a mask bearing a pattern which is adapted to the projection properties of the exposure apparatus such that h-v-differences are reduced relative to a corresponding mask without the modification responsible for the reduction of h-v-differences.

In addition to emerging from the claims, the present and further features also emerge from the description and the drawings. In this case, the individual features can respectively be implemented on their own or severally in the form of subcombinations in the case of an embodiment of the invention or in other fields, and can constitute embodiments that are advantageous and capable of protection per se.

### BRIEF DESCRIPTION OF THE DRAWINGS

FIG. 1 shows a schematic of a microlithography projection exposure apparatus according to an embodiment of the invention;

FIGS. 2(a), (b) show a schematic explaining the influence of the ellipticity of the illumination radiation in the region of a pupil surface of the projection objective, (a) showing the situation with a round diaphragm, and (b) showing the situation with an elliptical diaphragm; and

FIG. 3 shows a schematic of another microlithography projection exposure apparatus according to an embodiment of a the invention.

### DETAILED DESCRIPTION OF THE PREFERRED EMBODIMENTS

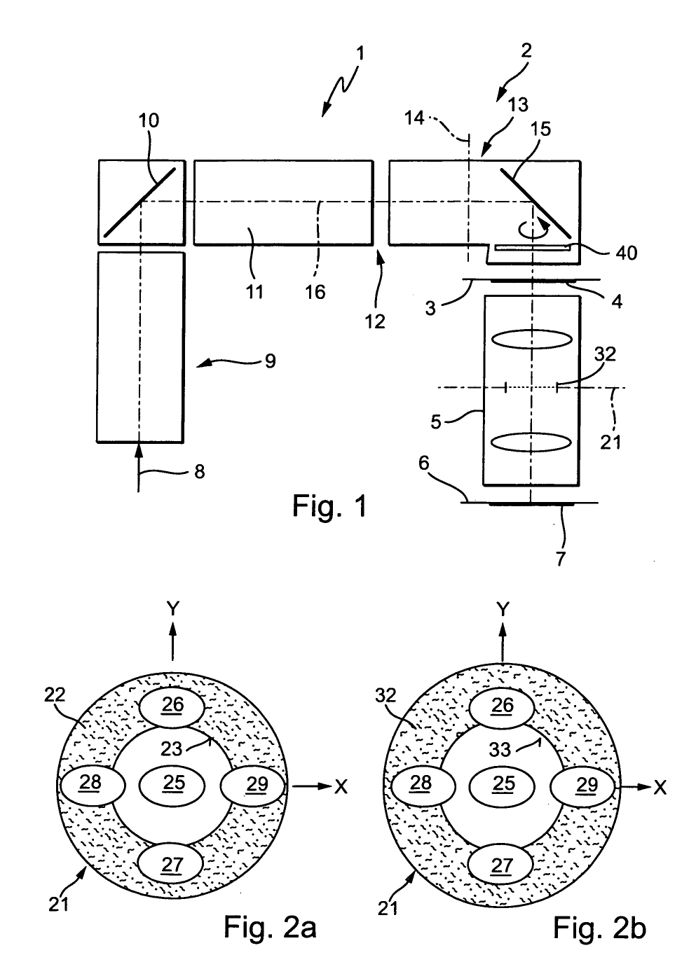

Shown schematically in FIG. 1 are essentially beam-guiding subassemblies of a microlithography projection exposure apparatus 1 that is provided for producing integrated circuits and other finely structured components at resolutions of down to 1 μm. The apparatus 1 comprises an illumination system 2 for illuminating a photomask 4 arranged in the image plane 3 of the illumination system, as well as a projection objective 5 that images the pattern of the photomask arranged in its object plane 3 into the image plane 6 of the projection objective on a reducing scale. For example, a semiconductor wafer 7 coated with a photosensitive layer is located in the image plane 6.

A laser (not shown), for example an Excimer laser common in the deep ultraviolet (DUV) region and having an operating wavelength of 248 nm, 193 nm or 157 nm is used as the light source in the illumination system. The light of the output laser beam 8 is largely linearly polarized. A downstream optical beam shaping device 9 shapes the light of the light source and transfers it via a 45° deflecting mirror 10 into a downstream light mixing device 11. The light is mixed inside the light mixing device 11 by multiple internal reflection, and emerges in a largely homogenized fashion at the exit 12 of the light mixing device 11. An intermediate field image in which a reticle masking system (REMA), that is to say an adjustable field stop, is arranged, is located directly at the exit 12 of the light mixing device. The downstream objective 13, which is also denoted as an REMA objective, has a number of lens groups, a pupil plane 14 and a deflecting mirror 15, and images the intermediate field plane and exit 12 of the light mixer onto the reticle or the photomask 4.

Further details on the design and mode of operation of such an illumination system may be gathered, for example, from EP 0 747 772 of the applicant, the content of which is incorporated in this application by reference.

The projection objective 5 is fashioned in the exemplary system as a purely refractive (dioptric) system that has precisely one pupil plane 21 between its object plane 3 and its image plane 6. An aperture stop 32 with an elliptical diaphragm opening (compare FIG. 2) is seated in the region of this pupil plane, that is to say directly in the pupil plane or in its vicinity. The pupil plane 21 is a Fourier-transformed plane relative to the reticle plane 3 and to the wafer plane 6, and so the planes 3 and 6 are optically conjugate to one another. The pupil plane 14 of the illumination system is in a Fourier relationship to the reticle plane 3. Consequently, the pupil plane 14 of the illumination system and the pupil plane 21 of the projection objective are optically conjugate to one another, that is to say pupil imaging takes place between them.

The apparatus is operated with largely unpolarized input light. The polarization state of the light will generally experience a variation owing to the optical components of the illumination system. In particular, because of the different reflectivities of the deflecting mirrors 10, 15 for s- and p-polarized light, the illumination light will generally be partially polarized at the reticle 4, and will have a preferred polarization direction. The polarization state of the illumination light can additionally also be influenced by photoelastically active parts in the illumination beam path, for example by components of calcium fluoride that are under stress. By illuminating a mask structure with partially polarized light, it is possible to produce contrast differences (h-v differences) dependent on structural direction.

The influence of the polarization on h-v differences can be understood with the aid of model considerations in the case of which the structure of the reticle is regarded as diffracting grating structure. According to Kirchhoff's law, the diffraction efficiency at a grating is a function of polarization. For light that is polarized parallel to the grating lines, it holds that:

$$u ( x , y , z ) \approx \frac{1}{λ} \int \int u ( {x}^{′} , {y}^{′} , {z}_{0} ) \frac{1}{2 r} {ⅇ}^{ⅈ ( \frac{2 π \cdot r}{λ} + \frac{π}{2} )} ⅆ {x}^{′} ⅆ {y}^{′}$$

For light that is polarized perpendicular to the grating lines, it holds that:

$$u ( x , y , z ) \approx \frac{1}{λ} \int \int u ( {x}^{′} , {y}^{′} , {z}_{0} ) \frac{cos ɛ}{2 r} {ⅇ}^{ⅈ ( \frac{2 π \cdot r}{λ} + \frac{π}{2} )} ⅆ {x}^{′} ⅆ {y}^{′}$$

The same law also describes the modulation swing during image production. In the case of high-aperture lithography objectives with image-side numerical apertures NA=0.8 or larger, the marginal rays can have angles of more than 53°. The corresponding value of the cosine in the above formulas then drops to approximately 0.6. This illustrates the fact that the difference in the modulation swing between orientations running parallel to the preferred polarization direction and running perpendicular to the preferred polarization direction can be considerable in the case of polarized light. A lower polarization degree of only 10% can also still lead to measurable h-v differences.

The different consistency of the illumination light for different structural directions can be described as deformation of the illumination pupil. In the case of conventional, partially coherent illumination, the illumination pupil is circular in an ideal system. Deviations therefrom by virtue of the fact that a specific direction perpendicular to the optical axis of the illumination system is more efficient for imaging than a direction perpendicular thereto can be described by means of an elliptical illumination pupil. The influence of the ellipticity of the illumination pupil on the imaging of different structural directions is described below with the aid of FIG. 2.

FIG. 2(a) is a schematic of a section, guided perpendicular to the optical axis, through the projection objective 5 in the region of its pupil plane 21. Seated in the pupil plane or in its vicinity is an aperture stop 22 with a circular diaphragm opening 23 whose shape and size determine the aperture used for the projection objective. It is only the radiation that comes from the reticle plane and penetrates through the diaphragm opening 23 that can contribute to imaging.

The pattern of the reticle is a crossed grating with grating lines in the x-direction and grating lines, perpendicular thereto, in the y-direction, the structures in both directions having substantially the same periodicity length. When use is made of conventional illumination of the reticle running substantially parallel to the optical axis, the reflection pattern shown, which can be described as Fourier transform of the grating structure, is produced in the region of the pupil plane 21. In this case, the illumination light that penetrates without diffraction produces a zeroth diffraction order 25 at the center of the pupil. The lines of the mask structure that run parallel to the x-direction (horizontally) produce first diffraction orders 26, 27 that are situated offset from the zeroth diffraction order in the y-direction, the spacing in the y-direction being determined by the periodicity length of the lines and by the wavelength. The vertical structures (parallel to the y-direction) produce first diffraction orders 28, 29 that are situated offset from the zeroth diffraction order in the x-direction.

The elliptical shape of the undiffracted fraction 25 symbolizes the influence of the ellipticity of the illumination pupil. These can result in the fact that the intensity of the diffracted light is substantially constant within the individual diffraction orders, whereas the shape or extent of the illumination pupil is a function of direction, for example in conjunction with a greater extent in the x-direction than in the y-direction. This would lead to a geometrically elliptical pupil. However, it is also possible for the illumination pupil to be geometrically round but to have an asymmetric (astigmatic) energy distribution. As a rule, both limiting cases occur in a real system, that is to say a geometrically unround illumination pupil with a nonuniform energy distribution within the illumination pupil, although the shape and/or energy distribution of the illumination pupil are ascribed, in turn, to different causes.

The problems are further explained below with reference to the simplified example of an energetically uniform but geometrically elliptical illumination pupil.

As explained above, a contribution to imaging can be made only by light that is situated within the diaphragm opening 23. It is to be seen that in the case of an elliptical pupil shape the fractions of the light transmitted in the first diffraction order are different for horizontal and vertical gratings. In the example, the diffraction orders 28, 29 that are caused by the vertical lines and are situated in the x-direction make a stronger contribution (with more light imaging) to imaging than the diffraction orders 26, 27 caused by the horizontal lines. Consequently, the vertical lines are imaged with a stronger contrast than the horizontal lines. The imaging contrast is thus a function of the structural direction of the imaged structures.

These imaging differences dependent on structural direction can be partially or completely compensated when use is made of an elliptical diaphragm opening. In this regard, FIG. 2(b) shows the illumination situation just described, although by contrast with FIG. 2(a) use is made in the pupil plane 21 of an aperture stop 32 with an elliptical diaphragm opening 33. The ellipse is aligned in this case with reference to the structural directions such that the longer semiaxis runs in the y-direction, that is to say a direction that was imaged with weaker contrast in the case of a circular diaphragm opening. It is possible thereby to achieve that in the case of the diffraction orders 26, 27 that stem from the horizontal structures more light energy (a larger fraction of the diffraction order) penetrates through the diaphragm opening 33 than happens with a round diaphragm opening. It may be seen that the shape of the elliptical diaphragm opening can be selected such that in the case of all first diffraction orders 26, 27, 28, 29 approximately the same light intensity (represented by surface fractions of the diffraction orders that are largely of the same size inside the diaphragm opening) make a contribution to imaging. It is possible thereby to achieve a far reaching or complete compensation of contrast differences dependent on structural direction.

The example illustrated in a greatly simplified fashion also shows that this compensate effect can be achieved not only with a geometrically elliptical diaphragm opening. It would also be possible to use a rectangular diaphragm opening of different edge lengths in order to achieve that substantially the same light energy makes a contribution to the lighting in the case of each of the first diffraction orders.

The mode of effect of an elliptical aperture stop has been explained here in a greatly simplified example. Consideration was given here to diffraction orders of particularly critical fine structures for which imaging takes place beyond the coherent diffraction limit. Under these conditions, the central beam of the diffracted pupil or of the first or higher diffraction orders is situated on or outside the edge of the diaphragm opening. The example shows that it is possible to set a largely complete compensation of h-v differences for a specific structural size (periodicity length). A good, approximate compensation can generally be achieved for other structural sizes.

The principle can also be applied when the pupil is energetically elliptical although being geometrically round, or when the case is a mixed one. The optimum shape of the astigmatic intervention in the transmission of the system in the region of a pupil surface can be determined by experiments.

The following numerical example may serve the purpose of estimating the order of magnitude of the achievable effects on the contrast. An ideal, catadioptric projection objective with NA=0.85 and an operating wavelength of λ=157 nm is considered. The aim is to image 70 nm lines with the aid of an annular illumination setting (σ=0.7-0.9). The achievable contrast may be defined in the usual way. The contrast is the same for both structural directions in the case of a circular diaphragm, being 57.5%. If, by contrast, use is made of an aperture stop whose diaphragm opening is smaller by 10% in the vertical direction than in the horizontal direction, a contrast of 54.5% is set up for the vertical direction, and a value of 51.7% for the horizontal direction. The reason why the contrast diminishes for the vertical structure is chiefly that annular illumination was used. If use were made of a phase mask with coherent illumination, this effect would be substantially smaller. Also possible are examples of diaphragm shapes where the contrast does not change, or does not change substantially for the less critical direction (for example the vertical direction) upon transition from a circular diaphragm to the elliptical diaphragm.

In the case of other embodiments, instead of an elliptically shaped diaphragm use is made of a graduated filter, for example an absorption filter with an elliptical transmission profile.

The projection exposure apparatus in FIG. 1 permits a fine tuning of the h-v correction that can be carried out during operation. This is achieved by virtue of the fact that the illumination system 2 is set up such that it provides in its exit plane (the reticle plane 3) partially polarized light with a preferred polarization direction which direction can be set with reference to the optical axis 16. To this end, a λ/2 plate 40 that is supported in a fashion capable of rotating about the optical axis 16 of the illumination system is arranged in the beam path of the illumination system downstream of the last deflecting mirror 15. It is known that a λ/2 plate (or an optical element of comparable retarding effect accomplishes a rotation of a preferred polarization direction of the incident radiation by 90°. In this case, partially or completely linearly polarized input light remains partially or completely linearly polarized at the exit. However, the rotatability of the element permits the alignment of the preferred polarization direction of the emerging radiation to be rotated about the optical axis. Since a preferred polarization direction of the illumination light can render a substantial contribution to the ellipticity of the illumination pupil, it is sensible if the illumination pupil can be rotated about the optical axis. For the illumination situation in FIG. 2, this means that the alignment of the elliptical diffraction orders 25, 26, 27, 28 can respectively be rotated about the center of the diffraction order. It is immediately to be seen that the fraction of the light that contributes to the image formation can be varied thereby. Consequently, a combination of the adjustment thereby possible in the degree of residual polarization of the illumination device with an astigmatic filter or an astigmatic diaphragm in the region of the pupil of the projection objective permits h-v differences to be corrected in an easy and stepless fashion.

The invention may advantageously be implemented into projection exposure apparatus using a catadioptric projection objective which includes one or more concave mirrors. Such projection objectives often have one or more planar deflecting mirrors to spatially separate the radiation beam section upstream of the concave mirror from the radiation beam section downstream of the concave mirror. Typically, a reflective coating provided on a planar deflecting mirror inclined to the optical axis tends to influence the polarization state of the radiation striking in the reflecting surface non-uniformly, such that different reflectivities occur for different polarization components (s- and p-polarized component of light). As mentioned above, a change of polarization state of the projection beam may be introduced, which causes or contributes to direction-dependent contrast differences in the image plane of the projection objective. The invention may be used to avoid or minimize those problems.

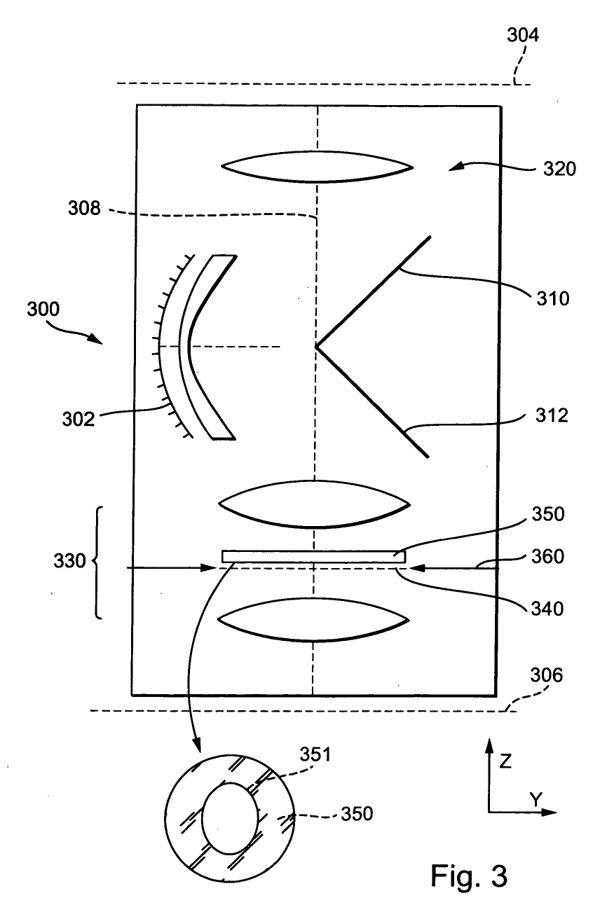

FIG. 3 shows a schematic representation of a catadioptric projection objective 300 having a single concave mirror 302 arranged optically between the object surface 304 and the image surface 306, which is aligned parallel to the object surface. A first planar deflection mirror inclined at 45° to the optical axis 308 is provided to deflect radiation coming from the object surface towards the concave mirror. A second planer deflection mirror 312 inclined at 90° to the first deflection mirror 310 is provided to deflect radiation reflected by the concave mirror 302 towards the image surface 306. Both deflection mirrors are coated with reflective coatings including a metal layer (typically aluminum) and a dialectric multilayer film coated on the metal layer. Typically, one or more transparent lenses 320 are provided between the object surface and the first deflection mirror 310. Further, a number of lenses 330 is provided between the second deflection mirror 312 and the image surface. An image-side pupil surface 340 optically conjugate to a pupil surface of the upstream illumination system (not shown) is present in the region of lenses 330.

The projection objective 300 is designed to image the pattern arranged in the object surface 304 onto an image surface 306 forming at least one intermediate image between object surface and image surface. One intermediate image typically is formed optically between the concave mirror 302 and the image surface, e.g. relatively close to the second deflection mirror 312 either immediately upstream or immediately downstream thereof. Another intermediate image may or may not be formed optically between the object surface and the concave mirror. For example, lenses 320 may be designed as a dioptric imaging subsystem forming a first intermediate image typically close to the first deflection mirror 310, e.g. immediately upstream or downstream thereof. This intermediate image may be imaged by the catadioptric second objective part (including the concave mirror) onto the second intermediate image, e.g. formed optically close to the second deflecting mirror 312, where the lenses 330 downstream thereof form a final dioptric imaging subsystem to image the second intermediate image onto the image surface 306. Examples of this design types having in that sequence a refractive, a catadioptric, and a refractive imaging subsystem (R-C-R Systems) are shown for example in WO 2005/111689 A2, the disclosure of which is incorporated herein by reference. Alternatively, in systems having only one intermediate image, a first catadioptric objective part forming the intermediate image includes the lenses 320 and the concave mirror 302, the first deflection mirror being situated within that catadioptric objective part. Representive examples of this design type (C-R-Designs) are shown, for example, in U.S. Pat. No. 6,496,306 B1. The disclosure of these documents is incorporated herein by reference.

In these catadioptric projection objectives the anisotropic influence of the deflection mirrors 310, 312 on the polarization state tends to cause or increase h-v-differences in the image plane 360. Projection objectives having two relatively inclined deflection mirrors are particulary sensitive to generating h-v-differences due to a breaking of a symmetry, since the rays contributing to image formation for different structural orientations of the pattern are incident on the deflection mirrors at different angles (or angular spectra), thereby suffering different changes upon reflection. This may be understood as follows. The plane (drawing plane of FIG. 3) including all sections of the optical axis in the refractive and catadioptric objective parts is denoted meridional plane or y-z-plane, where y is the direction of a scanning movement of mask and wafer in a wafer-scanner and z is oriented perpendicular to the object plane and image plane. With a given illumination setting, such as dipole illumination, the ray bundles of two diffraction orders generated by vertical structural elements (lines running parallel to the y direction or scanning direction) lying in planes perpendicular to the meridional plane impinge symmetrically with the same angular distribution of ray angles of incidence on the deflection mirrors. In contrast, ray bundles corresponding to diffraction orders generated by horizontal lines (lines in x-direction perpendicular to the scanning direction) include the meridional plane, thereby generating substantially different spectra of angles of incidence on the deflection mirrors. As the reflectivity of reflective coatings generally depends on the angles of incidence of incident radiation, these effects typically causes or contribute to generating h-v-differences in these types of projection objectives.

These problems are at least partly compensated for by providing an astigmatic optical element embodied as an elliptical diaphragm 350 at or near to the image-side pupil surface 340, for example immediately upstream or downstream of the variable apertures 360 provided in that region. The non-rotationally symmetric cross-sectional shape of the aperture 351 formed in the elliptical diaphragm having different diameters in mutually perpendicular directions perpendicular to the optical axis is adapted to the polarization changing properties and/or the incidence angle dependent reflectivities of the mirrors upstream thereof such that h-v-differences in the image surface 306 are largely avoided. If desired, the astigmatic influence on the projection radiation beam within the projection objective may be provided in addition to an astigmatic variation of the illumination radiation formed within the illumination system and striking the mask provided in the object surface 304.

The astigmatic optical element is advantageously positioned at or near to the image-side pupil surface of the projection objective, i.e. at or near to the last pupil surface in the optical train immedeately upstream of the image surface. Providing an astigmatic intervention on the projection beam in this position allows to compensate for all mentioned effects (independend of their physical origin) accumulated within the entire exposure system between the light source of the projection objective and the image-side pupil surface. Therefore, a very exact compensation may be obtained.

The invention may be implemented into different types of projection exposure systems. One type utilizes “dry objectives” where an image-side working distance between the exit surface of the projection objective and the image surface is filled with a gas (helium, air, nitrogen or the like). Another type includes immersion systems where an immersion medium having refractive index n substantially larger than 1 is employed. Immersion systems may be used to obtain image-side numerical aperture values NA>1. In an immersion system, a transparent liquid (for example pure water for λ=193 nm) may be introduced between the exit surface of the projection objective and the substrate to be exposed. Also, solid immersion providing contact between the exit surface of the projection objective and the substrate or near-field lithography (utilizing evanescent field emerging from the exit surface) may be used.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

What is claimed is:

1. An exposure method for producing an image of a pattern, arranged in the object surface of a projection objective, in the image surface of the projection objective, comprising:
illuminating the mask with illumination radiation in order to produce a radiation varied by the mask;
transirradiating the projection objective with the radiation varied by the mask;
astigmatically varying the radiation varied by the mask in the region of at least one pupil surface of the projection objective such that an anisotropy of properties of the radiation striking the image surface that leads to direction-dependent contrast differences is at least partially compensated.

2. The exposure method as claimed in claim 1, wherein the astigmatic variation comprises intervening in the transmission behavior of the projection objective in accordance with a non-rotationally symmetric transmission function.

3. The exposure method as claimed in claim 1, wherein the astigmatic variation comprises intervening in the polarization properties of the penetrating radiation in the region of the pupil of the projection objective.

4. The exposure method as claimed in claim 1, wherein the astigmatic variation comprises intervening with a substantially elliptic effect function.

5. The exposure method as claimed in claim 1, further comprising setting at least one property of the radiation upstream of the astigmatic variation of the radiation to be variable.

6. The exposure method as claimed in claim 5, wherein the variable setting comprises setting the polarization state of the radiation.

7. The exposure method as claimed in claim 1, wherein the polarization state of the illumination radiation striking the mask is varied such that the properties of the illumination radiation and the astigmatic variation of the radiation in the region of at least one pupil surface of the projection objective are adapted to one another such that direction-dependent contrast differences in the region of the image plane of the projection objective are at least partially compensated.

8. The exposure method as claimed in claim 7, wherein the variable setting of the illumination radiation comprises rotating a preferred polarization direction of the illumination radiation.

9. The exposure method as claimed in claim 5, wherein the variable setting comprises influencing the illumination radiation striking the mask by influencing the transmission behavior of the illumination system in accordance with a non-rotationally symmetric transmission function.

10. The exposure method according to claim 9, wherein the influencing of the transmission behavior of the illumination system and astigmatic variation of the radiation in the region of the at least one pupil surface of the projection objective are adapted to one another such that direction-dependent contrast differences in the region of the image plane of the projection objective are at least partly compensated.

11. The exposure method according to claim 9, wherein the influencing of the transmission behavior of the illumination system is performed by utilizing at least one astigmatic optical element arranged at or near a pupil surface of the illumination system.

12. The exposure method according to claim 9, wherein the influencing of the transmission behavior of the illumination system is performed by utilizing a transmission filter device defining an opening for passing a beam of illumination radiation, where the transmission filter device is configured such that the shape of the opening is variable.

13. The exposure method according to claim 1, wherein the projection objective is a catadioptric projection objective having at least one concave mirror and at least one planar deflecting mirror modifying the polarization state of projection radiation striking the mirrors, where the astigmatic variation of the radiation varied by the mask is adapted such that direction-dependent contrast differences in the image plane caused by the modification of the polarization state of the projection radiation are at least partly compensated.

14. A projection exposure apparatus for microlithographic production of at least one of semiconductor components and other finely structured subassemblies, comprising:
an illumination system illuminating a mask with illumination radiation;
a projection objective imaging a pattern, arranged in the object surface of the projection objective, of a mask into the image surface of the projection objective, at least one pupil surface lying between the object surface and the image surface; and
at least one astigmatic optical element, arranged in a region of the pupil surface, configured to astigmatically vary the radiation striking the optical element such that an anisotropy of properties of the radiation striking the image surface that leads to direction-dependent contrast differences is at least partially compensated.

15. The projection exposure apparatus as claimed in claim 14, wherein the astigmatic optical element has one of an astigmatic transmission function and an astigmatic reflection function.

16. The projection exposure apparatus as claimed in claim 15, wherein the astigmatic transmission function or the astigmatic reflection function is an elliptic function.

17. The projection exposure apparatus as claimed in claim 14, wherein the astigmatic optical element is a diaphragm defining an opening having a nonrotational symmetric shape.

18. The projection exposure apparatus as claimed in claim 14, wherein the astigmatic optical element is a diaphragm defining an opening having an elliptic shape.

19. The projection exposure apparatus as claimed in claim 14, wherein the astigmatic optical element is a filter having an astigmatic filter function.

20. The projection exposure apparatus as claimed in claim 14, wherein the astigmatic optical element has a variable effect function.

21. The projection exposure apparatus as claimed in claim 14, wherein the astigmatic optical element is a separate optical element in addition to the optical elements of the projection objective that are required for imaging.

22. The projection exposure apparatus as claimed in claim 14, wherein the astigmatic optical element comprises at least one coating, with an astigmatic effect function, applied to an optical surface of the projection objective.

23. The projection exposure apparatus as claimed in claim 14, wherein the astigmatic optical element is a diaphragm having an opening with a first diameter in a first direction and a second diameter smaller than the first diameter in a second direction perpendicular to the first direction.

24. The projection exposure apparatus as claimed in claim 14, wherein the astigmatic optical element is an astigmatic gray filter.

25. The projection exposure apparatus as claimed in claim 14, wherein the astigmatic optical element is an astigmatically deformed or deformable near-pupil optical element of the projection objective.

26. The projection exposure apparatus as claimed in claim 14, wherein the astigmatic optical element is an element with at least one astigmatically shaped optical surface having astigmatic dimensions.

27. The projection exposure apparatus as claimed in claim 14, wherein at least one variable optical element for variably influencing the properties of the radiation striking the astigmatic optical element is arranged in the beam path upstream of the astigmatic optical element.

28. The projection exposure apparatus as claimed in claim 27, wherein the variable optical element is arranged in the illumination system such that properties of the illumination radiation striking the mask are influenced with the aid of the variable optical element.

29. The projection exposure apparatus as claimed in claim 27, wherein the variable optical element is designed for influencing the polarization state of the illumination radiation.

30. The projection exposure apparatus as claimed in claim 29, wherein the variable optical element is a polarization rotating element configured to rotate a preferred polarization direction of the illumination radiation.

31. The projection exposure apparatus as claimed in claim 29, wherein the variable optical element is a retardation element with the effect of a λ/2 plate configured to be rotateable about an optical axis of the projection objective.

32. The projection exposure apparatus as claimed in claim 27, wherein the illumination system comprises at least one deflecting mirror and the variable optical element is arranged downstream of a last deflecting mirror of the illumination system.

33. The projection exposure apparatus as claimed in claim 27, wherein the illumination system has at least one pupil surface that is optically conjugate to a pupil surface of the projection objective, the variable optical element being arranged in the region of said pupil surface of the illumination system.

34. The projection exposure apparatus as claimed in claim 27, wherein the variable optical element is a variable filter.

35. The projection exposure apparatus as claimed in claim 34, wherein the variable filter is designed as a variable transmission filter device defining an opening for passing a beam of illumination radiation, where the transmission filter device is configured such that the shape of the opening is variable.

36. The projection exposure apparatus according to claim 14, wherein the projection objective is a catadioptric projection objective having at least one concave mirror.

37. The projection exposure apparatus according to claim 36, wherein the catadioptric projection objective includes at least one planar deflecting mirror.

38. The projection exposure apparatus as claimed in claim 37, wherein the catadioptric projection objective includes two planar deflecting mirrors inclined at right angles with respect to each other such that the object surface and the image surface are aligned parallel to each other.

39. The projection exposure apparatus as claimed in claim 36, wherein the catadioptric projection objective is configured to generate at least one intermediate image between the object surface and the image surface.

40. The projection exposure apparatus as claimed in claim 14, designed for radiation with wavelengths of less than 260 nm.

41. The projection exposure apparatus as claimed in claim 14, further comprising a mask bearing a pattern which is adapted to the projection properties of the exposure apparatus such that h-v-differences are reduced relative to a corresponding mask without the modification responsible for the reduction of h-v-differences.

42. The projection exposure apparatus as claimed in claim 14, wherein the astigmatic optical element is positioned at or near to an image-side pupil surface of the projection objective formed in the optical train immedeately upstream of the image surface.
